(19) United States
(12) Patent Application Publication
(10) Pub. No.: US 2026/0028707 A1
(43) Pub. Date: Jan. 29, 2026

(54) RAIL WELDING TRANSITION MATERIAL RESISTANT TO STRESS CORROSION DAMAGE AND PREPARATION METHOD THEREOF

(71) Applicant: Yanshan University, Qinhuangdao City (CN)

(72) Inventors: Chen CHEN, Qinhuangdao City (CN); Fucheng ZHANG, Qinhuangdao City (CN); Zhinan YANG, Qinhuangdao City (CN); Yanguo LI, Qinhuangdao City (CN)

(21) Appl. No.: 19/258,779

(22) Filed: Jul. 2, 2025

(30) Foreign Application Priority Data
Jul. 26, 2024 (CN) 202411012890.8

(51) Int. Cl. C22C 38/58; B23K 35/30; C21D 7/13; C22C 33/04; C22C 38/00; C22C 38/02; C22C 38/44; C22C 38/46; C22C 38/48

(52) U.S. Cl. CPC C22C 38/58; C21D 7/13; C22C 33/04; C22C 38/001; C22C 38/002; C22C 38/02; C22C 38/44; C22C 38/46; C22C 38/48; B23K 35/308

(57) ABSTRACT

A rail welding transition material resistant to stress corrosion damage and preparation method thereof, belonging to the technical field of welding transition materials. The rail welding transition material resistant to stress corrosion damage includes the following components in mass percentage: 0.02-0.04 percent (%) of Carbon (C), Silicon (Si)≤0.20%, 6.5-7.0% of Manganese (Mn), 11.0-11.5% of Nickel (Ni), 17.6-18.0% of Chromium (Cr), 2.1-2.4% of Molybdenum (Mo), 0.02-0.04% of Nitrogen (N), 0.05-0.15% of Niobium (Nb), 0.05-0.15% of Vanadium (V), Phosphorus (P)≤0.015%, Sulfur(S)≤0.010%; with the balance being Ferrum (Fe).

### CROSS-REFERENCE TO RELATED APPLICATIONS

This application claims priority to Chinese Patent Application No. 202411012890.8, filed on Jul. 26, 2024, the contents of which are hereby incorporated by reference.

### TECHNICAL FIELD

The present disclosure relates to the technical field of welding transition materials, and in particular to a rail welding transition material resistant to stress corrosion damage and a preparation method thereof.

### BACKGROUND

Rail welding transition materials are key to achieving high-quality welding between high-carbon steel rails and high-manganese steel frogs. To improve the service safety and stability of high-manganese steel frog welded joints, extensive research has been conducted in China and abroad on rail welding transition materials and flash welding processes. For example, CrMnNiMo series austenite-ferrite duplex steel has been used as a welding transition material to connect high-manganese steel frogs and carbon steel rails via flash welding, addressing stress corrosion cracking issues. However, morphology of ferrite in duplex steel is significantly affected by deformation, making the ferrite difficult to control, and cracks tend to propagate along the phase interfaces under welding residual stress, leading to joint failure; a low-carbon chromium-nickel austenitic steel stabilized with niobium or/and titanium has been used as a welding transition material to prevent grain boundary carbide formation and inhibit stress corrosion cracking, but this often results in insufficient strength, leading to fracture failure of the welding transition material; when high-carbon high-strength single-phase austenitic steel is used as the welding transition material, although high strength may be achieved, the high carbon content promotes carbide formation at austenite grain boundaries under welding heat influence, making the material highly susceptible to stress corrosion cracking in corrosive environments. It may be seen that the current welding transition materials have some problems, such as low strength and easy fracture, high carbon content and easy precipitation of grain boundary carbides, which may not be well used in the environment of heavy axle, high humidity and heavy corrosion. Therefore, there is a need to develop a welding transition material with stable microstructure, moderate strength, and resistance to stress corrosion damage.

### SUMMARY

The objective of the disclosure is to provide a rail welding transition material resistant to stress corrosion damage and preparation method thereof, so as to address the aforementioned issues in the prior art.

To achieve the above objective, the disclosure provides the following technical solutions:

Technical solution 1 of the disclosure: a rail welding transition material resistant to stress corrosion damage, includes the following components in mass percentage: 0.02-0.04 percent (%) of Carbon (C), Silicon (Si)≤0.20%, 6.5-7.0% of Manganese (Mn), 11.0-11.5% of Nickel (Ni), 17.6-18.0% of Chromium (Cr), 2.1-2.4% of Molybdenum (Mo), 0.02-0.04% of Nitrogen (N), 0.05-0.15% of Niobium (Nb), 0.05-0.15% of Vanadium (V), Phosphorus (P)≤0.015%, Sulfur(S)≤0.010%; with the balance being Ferrum (Fe).

Technical solution 2 of the disclosure: a method for preparing the above rail welding transition material includes the following steps:
mixing component raw materials, smelting, and casting to obtain a steel ingot;
subjecting the steel ingot to homogenization treatment, followed by pre-forging to obtain a forged billet; and subjecting the forged billet to hot deformation followed by rapid water cooling to obtain the rail welding transition material.

Further, the homogenization treatment is performed at 1200 degree Celsius (° C.), and heat preservation time is 10-13 hours (h).

Further, a forging ratio of the pre-forging is >4.

Further, the hot deformation includes hot extrusion or hot rolling.

Further, the hot extrusion is performed at 1050-1120° C.

Further, the hot rolling has an initial rolling temperature of 1000-1120° C. and a final rolling temperature not lower than 1000° C.

Further, the forged billet is a cylindrical extrusion ingot or a square elongated billet;

When the forged billet is the cylindrical extrusion ingot, hot extrusion is used for hot deformation; when the forged billet is the square elongated billet, hot rolling is used for hot deformation.

A single-phase austenitic short rail with grain grade of 8-9 and carbide-free grain boundaries is obtained by hot extrusion and hot rolling.

The disclosure discloses the following technical effects.

The rail welding transition material of the disclosure uses a low-carbon design and utilizes a carbon-nitrogen synergistic strengthening mechanism to enhance the austenitic stainless steel while keeping the total carbon and nitrogen content below 0.08, thereby reducing carbide formation tendency while achieving strengthening effects.

By controlling the Cr content (appropriately increasing the chromium content in the material), the disclosure ensures corrosion resistance in corrosive environments; by controlling the Mn content (increasing the manganese content in the material) and substituting Mn for Ni, the disclosure maintains a single-phase austenitic microstructure while reducing manufacturing costs.

Through component adjustments, the disclosure lowers the hot deformation temperature and inhibits static recrystallization growth after deformation by rapid water cooling, resulting in finer austenitic grains.

Lower hot deformation temperatures slow recrystallization grain growth, making it easier to obtain fine grains. Conventional extrusion temperatures (hot deformation temperatures) are typically 1150-1200° C., which may not be further reduced due to the risk of equipment accidents. The disclosure adjusts component types and proportions to reduce carbon content, which lowers high-temperature strength, enabling hot deformation at lower temperatures under constant extrusion or rolling force, thereby refining grains.

The rail welding transition material of the disclosure exhibits excellent strength and plasticity.

The rail welding transition material of the disclosure has advantages of minimal carbide formation tendency and fine grain, ensuring carbide-free grain boundaries under flash welding heat influence and resisting stress corrosion cracking.

### BRIEF DESCRIPTION OF THE DRAWINGS

To more clearly illustrate the embodiments of the disclosure or the technical solutions in the prior art, the accompanying drawings required for the embodiments are briefly described below. Obviously, the drawings in the following description are merely some embodiments of the disclosure. For those skilled in the art, other drawings may be obtained based on these drawings without creative effort.

FIG. 1 shows the optical image of the rail welding transition material prepared in Embodiment 1 of the disclosure.

FIG. 2 shows the optical image of the rail welding transition material prepared in Embodiment 2 of the disclosure.

FIG. 3 shows the optical image of the rail welding transition material prepared in Embodiment 3 of the disclosure.

FIG. 4 shows the optical image of the rail welding transition material prepared in Comparative Embodiment 1.

FIG. 5 shows the optical image of the rail welding transition material matrix after flash welding using the material prepared in Embodiment 1 of the disclosure.

FIG. 6 shows the optical image of the rail welding transition material matrix after flash welding using the material prepared in Comparative Example 1.

FIG. 7 shows a flow chart of the method for preparing the rail welding transition material of the present disclosure.

### DETAILED DESCRIPTION OF THE EMBODIMENTS

Various exemplary embodiments of the disclosure are described in detail below. This detailed description should not be construed as limiting the disclosure but rather as providing a more detailed explanation of certain aspects, features, and embodiments of the disclosure.

It should be understood that the terms used in the disclosure are only for describing specific embodiments and are not intended to limit the disclosure. Additionally, for numerical ranges in the disclosure, it should be understood that each intermediate value between the upper and lower limits of the range is also specifically disclosed. Any stated value or intermediate value within a stated range, as well as any smaller range formed by other stated values or intermediate values within the stated range, is also included in the disclosure. The upper and lower limits of these smaller ranges may be independently included or excluded from the range.

Unless otherwise specified, all technical and scientific terms used herein have the same meanings as commonly understood by those skilled in the art. Although only preferred methods and materials are described in the disclosure, any methods and materials similar or equivalent to those described herein may also be used in the implementation or testing of the disclosure. All documents mentioned in this specification are incorporated by reference to disclose and describe the methods and/or materials related to the documents. In case of conflict with any incorporated document, the content of this specification shall prevail.

Without departing from the scope or spirit of the disclosure, various modifications and changes may be made to the specific embodiments of the disclosure described herein, which will be obvious to those skilled in the art. Other embodiments obtained by those skilled in the art based on the description of the disclosure are also obvious. The description and examples of the disclosure are merely illustrative.

The terms “comprising,” “including,” “having,” “containing,” etc., used herein are open terms, meaning including but not limited to.

### Embodiment 1

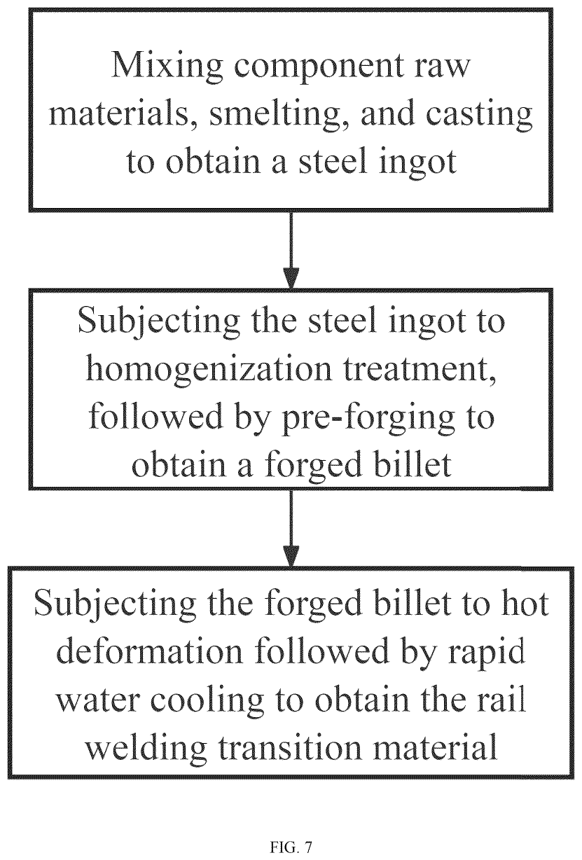

As shown in FIG. 7, a method for preparing a rail welding transition material resistant to stress corrosion damage.

(1) The rail welding transition material includes the following components in mass percentage: 0.02 percent (%) of Carbon (C), 0.10% of Silicon (Si), 6.8% of Manganese (Mn), 11.5% of Nickel (Ni), 17.7% of Chromium (Cr), 2.1% of Molybdenum (Mo), 0.04% of Nitrogen (N), 0.09% of Niobium (Nb), 0.09% of Vanadium (V), 0.013% of Phosphorus (P), 0.006% of Sulfur(S), with the balance being Ferrum (Fe).

(2) Mixing the component raw materials, smelting using an electric arc furnace and a refining furnace to obtain molten steel, and casting the molten steel to obtain a steel ingot.

(3) Subjecting the steel ingot to homogenization treatment at 1200 degrees Celsius (° C.) for 11 hours (h) to obtain a homogenized steel ingot.

(4) Pre-forging the homogenized steel ingot (using upsetting and long pulling processes with a forging ratio of 6) to obtain a cylindrical extrusion ingot with a diameter of 365 millimeter (mm) and a length of 650 mm.

(5) Heating the cylindrical extrusion ingot to 1100° C. (uniform temperature) using induction heating, then extruding the ingot into a UIC54-type short rail using a horizontal hot extrusion machine, followed by rapid water cooling (water entry temperature: 1080° C.) to obtain the rail welding transition material.

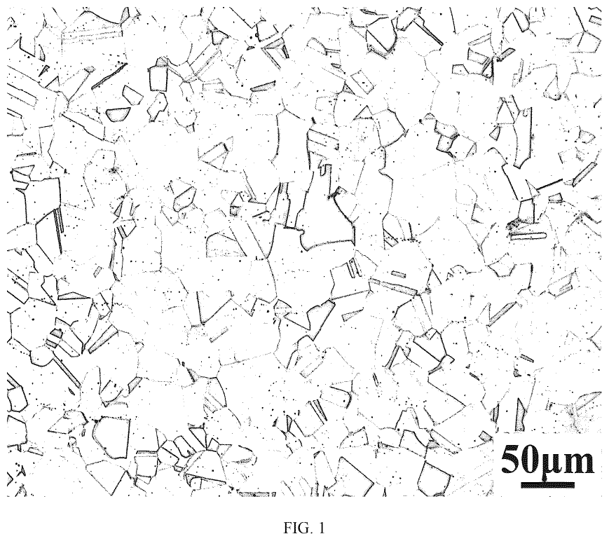

The structure of the rail head of the material prepared in this embodiment and the mechanical properties of the material were tested, with the results shown in FIG. 1 and Table 1.

TABLE 1
Mechanical properties of the rail welding transition material

| | Tensile | | Impact | |
|---|---|---|---|---|
| | Strength/ | Elongation/ | Energy/ | Hardness/ |
| State | MPa | % | J | HB |
| Embodiment 1 | 635 | 72 | 348 | 172 |
| Standard | ≥580 | ≥40 | ≥160 | ≥160 |
| Requirement | | | | |

As shown in FIG. 1 and Table 1, the rail welding transition material prepared in this embodiment exhibits a single-phase austenitic microstructure with an average grain size of 18.5 micrometers (μm) and a grain size level of 8.5. All mechanical properties far exceed the standard requirements for welding transition materials.

### Embodiment 2

A method for preparing a rail welding transition material resistant to stress corrosion damage.

(1) The rail welding transition material includes the following components in mass percentage: 0.04% of C, 0.13% of Si, 6.6% of Mn, 11.1% of Ni, 17.9% of Cr, 2.3% of Mo, 0.03% of N, 0.11% of Nb, 0.11% of V, 0.012% of P, 0.006% of S, with the balance being Fe.

(2) Mixing the component raw materials, smelting using an electric arc furnace and a refining furnace to obtain molten steel, and casting the molten steel to obtain a steel ingot.

(3) Subjecting the steel ingot to homogenization treatment at 1200° C. for 11 h to obtain a homogenized steel ingot.

(4) Pre-forging the homogenized steel ingot (using upsetting and long pulling processes with a forging ratio of 6) to obtain a square elongated billet.

(5) Heating the square elongated billet to 1105° C. (uniform temperature) using a walking beam furnace, then rolling the billet into a UIC54-type short rail using a rail forming machine in three passes, with an initial rolling temperature of 1080° C. and a final rolling temperature of 1035° C., followed by rapid water cooling to obtain the rail welding transition material.

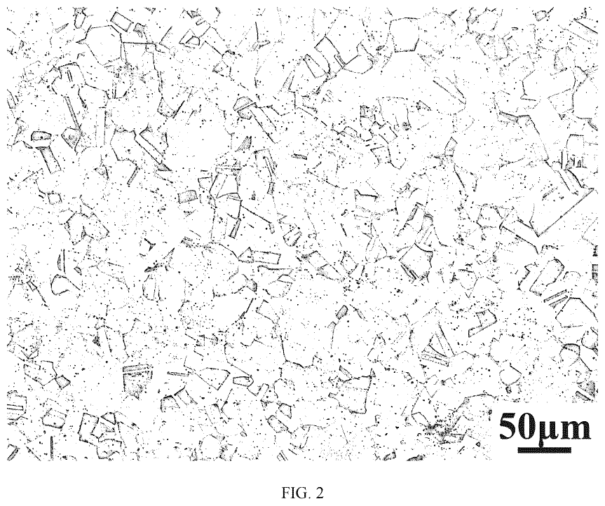

The structure of the rail head of the material prepared in this embodiment and the mechanical properties of the material were tested, with the results shown in FIG. 2 and Table 2.

TABLE 2
Mechanical properties of the rail welding transition material

| | Tensile | | Impact | |
|---|---|---|---|---|
| | Strength/ | Elongation/ | Energy/ | Hardness/ |
| State | MPa | % | J | HB |
| Embodiment 2 | 642 | 70 | 328 | 175 |
| Standard Requirement | ≥580 | ≥40 | ≥160 | ≥160 |

As shown in FIG. 2 and Table 2, the rail welding transition material prepared in this embodiment exhibits a single-phase austenitic microstructure with an average grain size of 15.5 μm and a grain size level of 9.0. All mechanical properties far exceed the standard requirements for welding transition materials.

### Embodiment 3

A method for preparing a rail welding transition material resistant to stress corrosion damage.

(1) The rail welding transition material includes the following components in mass percentage: 0.03% of C, 0.13% of Si, 6.8% of Mn, 11.2% of Ni, 17.9% of Cr, 2.4% of Mo, 0.03% of N, 0.13% of Nb, 0.13% of V, 0.011% of P, 0.008% of S, with the balance being Fe.

(2) Mixing the component raw materials, smelting using an electric arc furnace and a refining furnace to obtain molten steel, and casting the molten steel to obtain a steel ingot.

(3) Subjecting the steel ingot to homogenization treatment at 1200° C. for 11 h to obtain a homogenized steel ingot.

(4) Pre-forging the homogenized steel ingot (using upsetting and long pulling processes with a forging ratio of 6) to obtain a cylindrical extrusion ingot with a diameter of 365 mm and a length of 650 mm.

(5) Heating the cylindrical extrusion ingot to 1080° C. (uniform temperature) using induction heating, then extruding the ingot into a UIC54-type short rail using a horizontal hot extrusion machine, followed by rapid water cooling (water entry temperature: 1069° C.) to obtain the rail welding transition material.

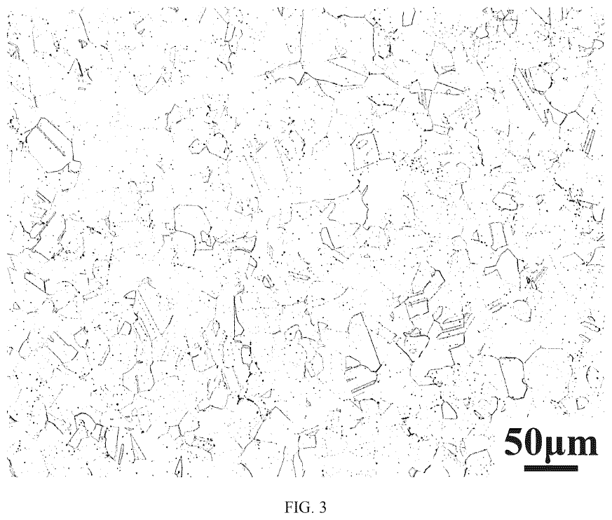

The structure of the rail head of the material prepared in this embodiment and the mechanical properties of the material were tested, with the results shown in FIG. 3 and Table 3.

TABLE 3
Mechanical Properties of the rail welding transition material

| | Tensile | | Impact | |
|---|---|---|---|---|
| | Strength/ | Elongation/ | Energy/ | Hardness/ |
| State | MPa | % | J | HB |
| Embodiment 3 | 641 | 69 | 337 | 176 |
| Standard Requirement | ≥580 | ≥40 | ≥160 | ≥160 |

As shown in FIG. 3 and Table 3, the rail welding transition material prepared in this embodiment exhibits a single-phase austenitic microstructure with an average grain size of 16.5 μm and a grain size level of 8.5. All mechanical properties far exceed the standard requirements for welding transition materials.

### Comparative Example 1

(1) The rail welding transition material includes the following components in mass percentage: 0.12% of C, 0.10% of Si, 6.9% of Mn, 11.8% of Ni, 17.5% of Cr, 2.3% of Mo, 0.012% of P, 0.008% of S, with the balance being Fe.

(2) Mixing the component raw materials, smelting using an electric arc furnace and a refining furnace to obtain molten steel, and casting the molten steel to obtain a steel ingot.

(3) Subjecting the steel ingot to homogenization treatment at 1200° C. for 12 h to obtain a homogenized steel ingot.

(4) Pre-forging the homogenized steel ingot (using upsetting and drawing processes with a forging ratio of 6) to obtain a cylindrical extrusion ingot with a diameter of 365 mm and a length of 650 mm.

(5) Heating the cylindrical extrusion ingot to 1150° C. (uniform temperature) using induction heating, then extruding the ingot into a UIC54-type short rail using a horizontal hot extrusion machine, followed by rapid water cooling (water entry temperature: 1136° C.) to obtain the rail welding transition material.

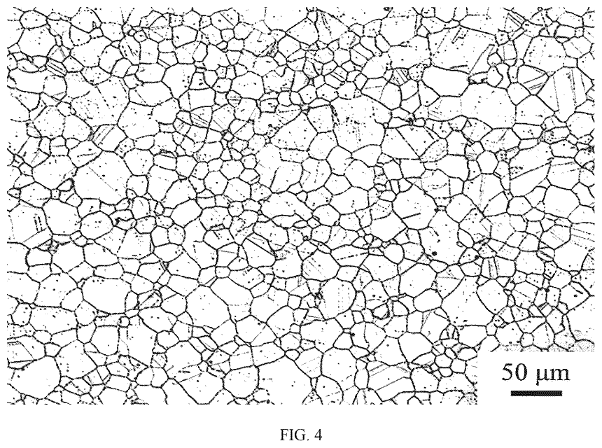

The structure of the rail head of the material prepared in this comparative embodiment and the mechanical properties of the material were tested, with the results shown in FIG. 4 and Table 4.

TABLE 4
Mechanical properties of the rail welding transition material

| | Tensile | | Impact | |
|---|---|---|---|---|
| | Strength/ | Elongation/ | Energy/ | Hardness/ |
| State | MPa | % | J | HB |
| Comparative | 642 | 62 | 246 | 180 |
| Embodiment 1 | | | | |
| Standard Requirement | ≥580 | ≥40 | ≥160 | ≥160 |

As shown in the Table 4, the welding transition material in this comparative embodiment meets the standard requirements but exhibits significantly lower plasticity compared to the embodiments.

As shown in the FIG. 4, the welding transition material exhibits partial carbide precipitation at grain boundaries, with an average grain size of 35 μm and a grain size level of 6.5.

### Effect Example 1

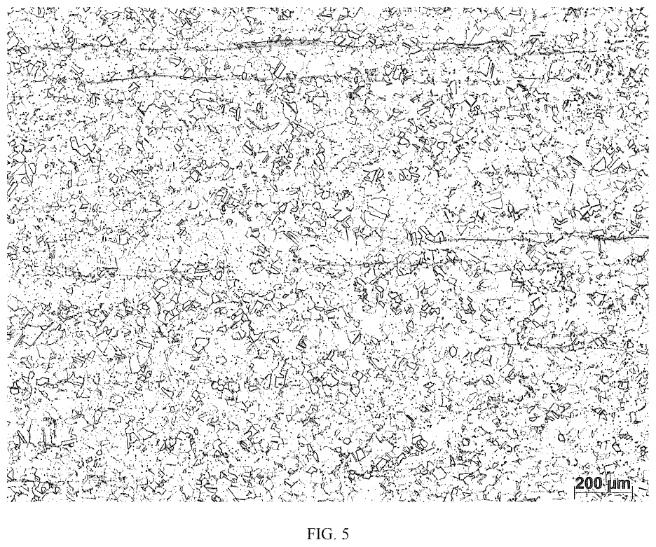

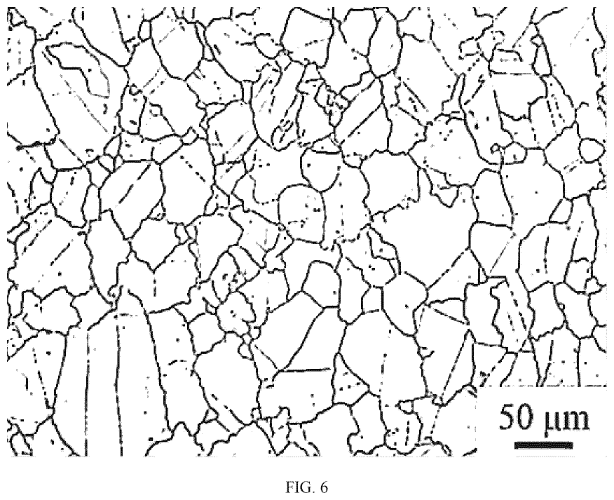

Using the rail welding transition materials prepared in Embodiment 1 and Comparative Embodiment 1 as welding transition materials for flash welding between high-manganese steel frogs and high-carbon steel rails, the microstructures of the welded materials were observed, with the results shown in FIG. 5 and FIG. 6, respectively.

As shown in FIG. 5 and FIG. 6, under the influence of welding thermal cycles, the rail welding transition material prepared in Embodiment 1 of the disclosure maintains clean grain boundaries without carbide formation, thereby avoiding stress corrosion cracking near the grain boundaries. In contrast, the welding transition material prepared in Comparative Embodiment 1 exhibits severe grain boundary carbide formation under welding thermal cycles.

Slow strain rate tensile tests were conducted on the welded transition materials from Embodiment 1 and Comparative Embodiment 1 in a 3.5 wt. % NaCl solution, with the results shown in Table 5.

As shown in the Table 5, the material from Embodiment 1 exhibits higher strength and plasticity, demonstrating superior resistance to stress corrosion cracking.

TABLE 5
Slow strain rate tensile properties of welding transition
materials after welding thermal cycles

| State | Tensile strength/MPa | Elongation/% |
|---|---|---|
| Embodiment 1 | 359 | 27 |
| Comparative Embodiment 1 | 263 | 16 |

The embodiments described above are merely illustrative of the preferred implementations of the disclosure and are not intended to limit the scope of the disclosure. Without departing from the design spirit of the disclosure, various modifications and improvements made by those skilled in the art to the technical solutions of the disclosure shall fall within the protection scope defined by the claims of the disclosure.

1. A rail welding transition material resistant to stress corrosion damage comprises the following components in mass percentage: 0.02-0.04% of C, Si≤0.20%, 6.5-7.0% of Mn, 11.0-11.5% of Ni, 17.6-18.0% of Cr, 2.1-2.4% of Mo, 0.02-0.04% of N, 0.05-0.15% of Nb, 0.05-0.15% of V, P≤0.015%, S≤0.010%; with the balance being Fe.

2. A method for preparing a rail welding transition material resistant to stress corrosion damage, the rail welding transition material comprising the following components in mass percentage: 0.02-0.04% of C, Si≤0.20%, 6.5-7.0% of Mn, 11.0-11.5% of Ni, 17.6-18.0% of Cr, 2.1-2.4% of Mo, 0.02-0.04% of N, 0.05-0.15% of Nb, 0.05-0.15% of V, P≤0.015%, S≤0.010%, with the balance being Fe, the method comprising the following steps:
mixing the components as raw materials, smelting, and casting to obtain a steel ingot; and
subjecting the steel ingot to homogenization treatment, followed by pre-forging to obtain a forged billet; and subjecting the forged billet to hot deformation followed by rapid water cooling to obtain the rail welding transition material.

3. The method for preparing the rail welding transition material according to claim 2, wherein the homogenization treatment is performed at 1200° C., and heat preservation time is 10-13 h.

4. The method for preparing the rail welding transition material according to claim 2, wherein a forging ratio of the pre-forging is >4.

5. The method for preparing the rail welding transition material according to claim 2, wherein the hot deformation comprises a hot extrusion.

6. The method for preparing the rail welding transition material according to claim 5, wherein the hot extrusion is performed at 1050-1120° C.

7. The method for preparing the rail welding transition material according to claim 5, wherein the hot rolling has an initial rolling temperature of 1000-1120° C. and a final rolling temperature not lower than 1000° C.
